(19) United States
(12) Patent Application Publication
(10) Pub. No.: US 2003/0018981 A1
(43) Pub. Date: Jan. 23, 2003

(54) System and method for displaying CATV diagnostic data

(76) Inventor: Jeffrey Ramsey, Indianapolis, IN (US)

Correspondence Address: Harold C. Moore, Maginot, Addison & Moore, Bank One Center/Tower, 111 Monument Circle, Suite 3000, Indianapolis, IN, 46204-5115, US

(21) Appl. No.: 09/907,548

(22) Filed: Jul. 17, 2001

(51) Int. Cl. H04N 7/16

(52) U.S. Cl. 725/148; 725/118; 725/143; 725/105

(57) ABSTRACT

A system for displaying receiver and channel diagnostic data includes a channel response generator, a channel response pass/fail limit storage, and a display generator for generating a display of the generated response and a limit stored within the pass/fail limit storage. The channel response generator generates one of a magnitude and phase angle response from response data for a QAM receiver and may be any device that computes at least a magnitude channel response or a phase angle response for a QAM or QPSK receiver. For each type of channel response, magnitude and phase angle, a user may specify a variation limit and/or the system may store default variation limits. These variation limits define the limit of gain variation from unity gain for the magnitude response and the maximum group delay variation. Preferably, the group delay is measured with respect to the group delay at the center frequency of the channel to which the receiver is tuned. The pass/fail limits are displayed in conjunction with the channel response data, preferably, as longitudinal or horizontal segments on the display. Thus, the user may easily determine whether the magnitude gain variation exceeds the limit or whether some frequency within the channel bandwidth has an associated phase angle/frequency change ratio that exceeds the group delay limit. The system also identifies the distances from the receiver associated with the equalizer tap coefficients and a hierarchical zoom mode for viewing constellation patterns.

This application cross-references co-pending U.S. patent application Ser. No. 09/851,892 entitled System and Method for Determining the Phase Angle Response of a Receiver in a CATV System filed May 9, 2001. The content of that patent application is hereby expressly incorporated herein.

### FIELD OF THE INVENTION

The present invention relates generally to analyzing transmission characteristics of an RF communication network, and more particularly, to displaying characteristics of a receiver in a CATV communication network.

### BACKGROUND OF THE INVENTION

In broad terms, a radio frequency (“RF”) communication network supports transmission of information signals from a source location to a destination location through (or “over” or “on”) an RF communication channel. Depending on the application, the information signals may be analog or digital in nature. Digital signals tend to afford significant advantages relative to analog techniques, such as, for example, improved noise immunity and facilities for encryption, which can provide enhanced communication reliability and security, respectively. Analog and digital transmissions propagate an information signal through a communication medium by converting the information signal into a form suitable for effective transmission over the medium. The propagation medium of an RF communication network may support the simultaneous transmission of more than one information signal by dividing the frequency spectrum of the propagation medium into discrete bandwidth groupings called channels and providing a carrier wave for each channel. The information signal is usually used to vary a parameter of the carrier wave for a channel so the frequency spectrum of the modulated carrier is confined within the bandwidth of one of the channels defined for a propagation medium. A receiver at a destination location receives the modulated carrier waves for the channels to which the receiver is tuned. The received may then recover a version of the original information signal from the modulated carrier received from the corresponding channel of the propagation medium. The recovery process includes demodulation of the received signal in a manner that is generally the inverse of the modulation performed by the source transmitter.

A cable television (“CATV”) network is one type of RF communication network. CATV networks have grown in importance and use for transmitting television and other information signals to various analog and/or digital devices such as analog television sets and/or personal computers, respectively, and, lately, for a growing number of digital television sets. Originally, CATV networks were used in locations that could not directly receive over-the-air television transmissions because of large distances between transmitters and receivers or because of interfering buildings or terrain. The propagation medium for such systems is coaxial cable because it shields signals carried by the cable from electromagnetic and radio frequency interference better than air. RF communication networks that transmit signals principally through the earth's atmosphere (such as traditional radio and television networks) are prone to noise interference and they require a “line of sight” communication path. In recent years, cable transmissions have become popular even in areas where receptions of over-the-air television broadcasts are satisfactory. In these areas, the wide bandwidth of CATV networks has been increasingly exploited to provide additional channels and new services that have not been available from traditional television networks, such as bidirectional communications and videotext. Bi-directional communication may be implemented on a single coaxial cable by dividing the available frequency spectrum of a channel on the cable into two sub-channels. The forward sub-channel carries signals in the forward or downstream (away from the head end) direction and the return sub-channel carries signals in the reverse or upstream (toward the head end) direction. A customer device attached to the network receives signals from the head end on a forward sub-channel and transmits signals to the head end on a return sub-channel.

A typical CATV system includes a head end where information signals are originated for distribution to subscribers over a network of coaxial cable. Individual subscriber sites are coupled to the network through taps. Also, disbursed throughout the network are distribution sites where amplifiers are located. These amplifiers may include filters that are used to remove distortions in the signals and then the filtered signal is amplified to ensure an adequate signal-to-noise ratio (SNR) of the signal is maintained during its propagation through the system to the next distribution site or tap. As the number of customers and the development of new services grow, the electrical loads on the network increase and the communication operations of a CATV network becomes increasingly complex. CATV networks not only require verification testing during construction and/or expansion to confirm that the network can reliably carry signals but further periodic testing is required to ensure the transmission design characteristics of the network remain stable. Additionally, complex RF communication networks, such as CATV networks, suffer occasional problems and failures from component failure or fatigue. When such problems arise, the component causing the problem must be located so that it may be repaired or replaced.

One method used for verifying reliable operation of a CATV and other RF communication networks is by testing the quality of signals received at various locations in the network. Heretofore, this has been accomplished by using a head end test unit to inject a reference signal into the network portion under test and measuring (relative to the reference signal) the magnitude and phase of the signal received at one or more remote locations on the network. A remote test unit located at a distribution site or subscriber tap on the network typically measures the demodulated signal received at the site. To thoroughly test a channel, the reference signal was injected into each frequency of the bandwidth across a channel supported by the network. This has been accomplished by “sweeping” the frequencies of each channel supported by the network with the reference signal and measuring the magnitude and phase of each signal received at the remote location. The testing process typically required the head end to send a telemetry signal to the remote test unit followed by the frequency sweep reference signals. The telemetry signal synchronized the remote test unit to the head end test unit for the frequency sweep. At the end of the sweep, the head end test unit then again sent telemetry signals to the remote test unit for another frequency sweep. In addition to synchronizing the remote test unit to the head end test unit for a sweep, the telemetry signals also identify the frequencies to be swept and the voltage level (magnitude) of the reference signal to be injected. The remote test unit uses this information and its own measurements to determine the frequency response characteristics of the network at the site of the remote test unit. The remote test unit may then display the frequency response data.

One problem with frequency sweep testing techniques is disruption of subscriber service. When the sweep is being performed, the reference signal being injected by the head end test unit interferes with the subscriber's reception of a channel as it is swept. Although this interruption is brief, it is noticeable. Because a frequency sweep test is usually conducted more than once, the disruption occurs several times. To address this problem, techniques for obtaining data without significantly disrupting service have been developed. U.S. Pat. No. 5,751,766 to Kletsky et al. (“Kletsky”) shows a method and apparatus for non-invasively testing the performance of a digital communication system. One embodiment is used to diagnose digital television cable broadcast systems. The test system uses the filter parameters of an adaptive equalizer of a digital receiver to correct for communication channel imperfections. The pseudoinverse of the transfer function of this adaptive equalizer is then used to compute the amplitude-frequency response, also known as magnitude response, of all of the components that are in the propagation path of the signal up to the input of the adaptive equalizer. In Kletsky, the pseudoinverse of the equalizer transfer function may either be determined from the weights of the adaptive equalizer or from the weights of a second adaptive equalizer that converges to the demodulated signal received from the channel. However, the previously known “in-service” systems do not compute a phase response from the weights of an adaptive equalizer. Yet, with the increasing use of complex modulation schemes (such as QPSK and increasing orders of QAM), effective characterization and maintenance of the phase responses of CATV networks are becoming increasingly important.

Accordingly, there is a need for a technique for obtaining a phase response at a single site in a CATV system or between two sites in a CATV network without significantly disrupting communication through the network or at one or more sites. In particular, there is a need for measuring the group delay of a demodulated signal. Group delay indicates the delay imparted to the signal by the network components and cable between a head end transmitter and the demodulation components of a receiver. Because group delay is derived from the phase response, there is a need to obtain and measure the phase response of the portion of the CATV network that presents the demodulated signal to a receiver. Such a system is disclosed in the co-pending patent application cross-referenced above.

While graphical display of group delay alone from such a system is useful, notification of deterioration of the group delay characteristic beyond an acceptable limit would facilitate a user's evaluation of the network. Thus, there is a need to graphically display the group delay characteristic with the acceptable limit for the characteristic in a way that facilitates user evaluation of the network. Additionally, network characteristics such as the time delay and distance from network faults are not currently displayed although diagnostic data that facilitates fault location and that is computed from the tap coefficients is currently known. Likewise, zoom views of points within a constellation display of received data for a QAM receiver are known; however, a user selects a point for a zoom view. Consequently, the user may lose his or her reference with respect to the overall constellation display and need to leave zoom mode to re-orient the user's perspective. What is needed is a method for moving through a zoom view that easily provides a user with reference to the overall constellation view.

### SUMMARY OF THE INVENTION

The limitations of the previously known CATV network testing devices are overcome by a system implementing the method of the present invention. The system includes a channel response generator for generating one of a magnitude and phase angle response from QAM receiver data, a channel response pass/fail limit storage, and a display generator for generating a display of the generated response and a limit stored within the pass/fail limit storage. The channel response generator may be any device that computes at least a magnitude response or a phase angle response of a QAM or QPSK receiver. A device capable of computing a phase angle response is disclosed in the co-pending application cross-referenced above and Kletsky et al discloses a magnitude response generating device. For each type of channel response, magnitude and phase angle, a user may specify a variation limit and/or the system may store default variation limits. These variation limits define the limit of gain variation from unity gain for the magnitude response and the maximum variation in group delay. Preferably, the group delay is measured with respect to the group delay at the center frequency. The pass/fail limits are displayed in conjunction with the channel response data, preferably, as longitudinal or horizontal segments on the display. Thus, the user may easily determine whether the magnitude gain variation exceeds the limit or whether some frequency within the channel bandwidth has an associated group delay that exceeds the group delay limit. Another feature of the present invention permits a user to identify two frequencies within the channel bandwidth and the system responds with a display of the maximum variation of gain or group delay within the interval, depending upon the channel response being displayed.

In another aspect of the present invention, the tap coefficients of the adaptive equalizer in a QAM receiver are correlated to a distance from the receiver through the time delay associated with each coefficient. A channel response processor receives the tap coefficients and uses the time delay for each coefficient and the propagation constant of the communication medium to compute a distance from the receiver for each coefficient. These distances are provided to the display generator for display in conjunction with a display of the tap coefficient values that are preferably shown in decibels with reference to the amplitude of the center tap coefficient. Such a display reveals information that may be used to determine the distance to network faults from the receiver.

In yet another aspect of the present invention, cursor movement controls a zoom mode for a constellation display. At the initial activation of the zoom control, the cursor moves from quadrant to quadrant so the display generator displays the quadrant to which the cursor currently points on the display screen. Thus, at the first level of zoom mode, each quadrant occupies the full screen rather than a quarter of the screen. The next activation of zoom mode causes the display generator to display on the full screen a quadrant of the quadrant in which the cursor resided when the second activation occurred. Thus, the second level of zoom mode remains within a specific quadrant of the original constellation display and causes only a quarter of the quadrant to be displayed at a time. Successive activation of the zoom mode continues to divide the current level of display into quadrants for occupying the display screen until the display becomes a single point. At any point during the zoom mode, a user may activate a zoom out mode to back up one level of zoom.

The system incorporating the method of the present invention may be included in a network analyzer. When the analyzer is used at a distribution site or subscriber tap, it provides information regarding the variation of the magnitude and phase angle responses against pass/fail limits, facilitates observation of channel responses at particular distances from the receiver and coherently presents zoom views of a constellation display.

The method of the present invention includes computing one of a magnitude and a phase angle response of a QAM receiver, and displaying the computed response with a pass/fail limit. The contemporaneous display of the magnitude or phase angle response with the pass/fail limits facilitates an evaluation of the channel response to the propagation of a signal via the channel of interest. Likewise the group delay may be computed from the phase angle response and displayed with limits for a similar purpose.

Another inventive method of the present invention includes receiving the tap coefficients of an equalizer with a QAM receiver, correlating a distance from the receiver with a tap coefficient, and displaying the correlated distance with its corresponding tap coefficient. The displayed value of a tap coefficient and its correlated distance may be used to locate faults in the network.

A zoom view method of the present invention includes detecting activation of a zoom mode during display of a constellation pattern, and expanding a quadrant of the constellation pattern being displayed to occupy a full display screen. The method further includes moving the cursor to a quadrant of a current view of the constellation pattern and activating the zoom mode to fill the display with the portion of the constellation pattern corresponding to the location of the cursor before activation of the zoom mode. This method allows successive views of expanded data and the orderly advance through zoom levels down to a single point in the constellation pattern. The method further includes detecting activation of a zoom out mode to return to the previous zoom level for the display.

The system and method of the present invention may be used to display magnitude and phase angle response as well as other data for a communication channel in a CATV communication network without disrupting subscriber service. The phase angle response data may be used to determine the group delay of the channel being evaluated. The magnitude, phase angle, and group delay information may be displayed in conjunction with pass/fail limits to facilitate evaluation of these receiver characteristics. Likewise, specific locations of channel responses may be displayed for channel evaluation. Alternatively, the system and method of the present invention may be implemented in a digital receiver and used for receiver analysis at a distribution or subscriber site. If the receiver does not include a display the display data may be stored for later retrieval or it may be transmitted over a telemetry channel or the like to the head end for analysis.

These and other advantages and features of the present invention may be discerned from reviewing the accompanying drawings and the detailed description of the invention.

### BRIEF DESCRIPTION OF THE DRAWINGS

The present invention may take form in various components and arrangement of components and in various steps and arrangement of steps. The drawings are only for purposes of illustrating an exemplary embodiment and are not to be construed as limiting the invention.

FIG. 1 is a schematic of an exemplary CATV communication network in which the present invention may be used;

FIG. 2 is a graphical depiction of a digital modulation scheme that may be used in the network of FIG. 1;

FIG. 3 is a block diagram of a receiver and channel response processor with components that may be used to implement the methods of the present invention;

FIG. 4 is a flowchart of an exemplary method that may be used in the system of FIG. 3 to compute and display with pass/fail limits a response of a channel used in the network of FIG. 1;

FIG. 5 is a flowchart of an exemplary method that may be used in the system of FIG. 3 to compute and display a distance associated with a tap coefficient of an equalizer within the receiver of FIG. 3;

FIG. 6 is a flowchart of an exemplary method that may be used in the system of FIG. 3 to present successive zoom views of a constellation pattern in response to activation of a zoom mode;

FIG. 7A is an exemplary display generated by the method of FIG. 4 for a magnitude response with pass/fail limits;

FIG. 7B is an exemplary display generated by the method of FIG. 4 for group delay with pass/fail limits;

FIG. 8 is an exemplary display of a coefficient and its corresponding distance generated by the method of FIG. 5; and

FIGS. 9A, 9B, 9C are exemplary displays of zoom views generated by the method of FIG. 6.

### DETAILED DESCRIPTION OF THE INVENTION

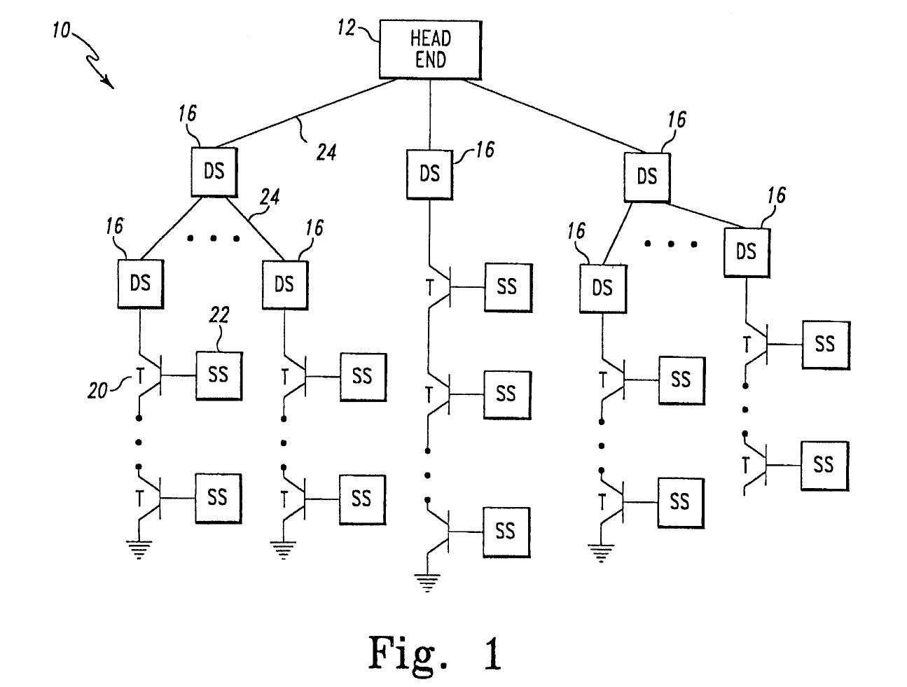

FIG. 1 depicts a schematic of a CATV communication network in which the present invention may be used. Content signals are generated via playback machines or received via satellite and the like at head end 12 of network 10 and these information signals are used to modulate carrier frequencies on various channel frequencies of network 10. Network 10 is further comprised of distribution sites 16, subscriber taps 20, and subscriber sites 22. These sites are coupled together by a propagation medium 24 that is typically coaxial cable or fiber optic cable. The frequency spectrum of the propagation medium is divided into channels that are typically 6 MHz wide and that are centered about the frequency used to define the channel. That is, some frequency Ω_{ch} is the center frequency of the channel and frequencies approximately 3 MHz above and below that frequency are deemed to be within the channel. A carrier wave at the channel frequency is modulated with an information signal to provide content for the channel. The modulated carrier frequencies for all of the channels on which network 10 provides content are transmitted via a transmitter at head end 12 to a plurality of distribution sites 16. The signals are amplified for further transmission at distribution sites 16. From a distribution site 16, the signals may be delivered over propagation medium 24 to other distribution sites 16 or to a plurality of subscriber sites 22 via subscriber taps 20. Taps 20 provide the frequency spectrum of propagation medium 24 to a subscriber site 22 with little attenuation of the signals being transmitted in the bandwidth of medium 24. That is, taps 20 are designed to provided the signals on medium 24 to a subscriber site 22 without causing parasitic loss of signals on medium 24. The signals are decoded at the subscriber site and used to drive televisions, computers, or the like.

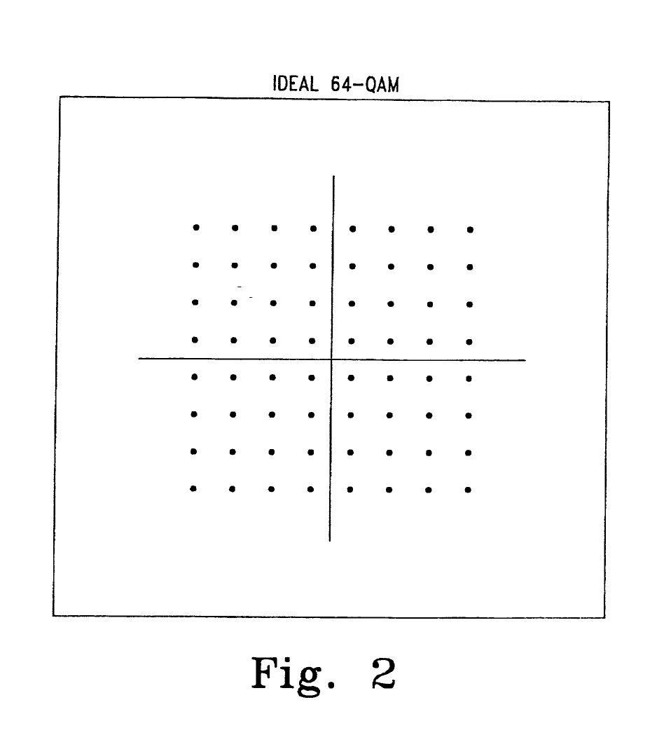

A common modulation scheme used in known CATV systems is the QAM modulation scheme. Pixel data of images, such as the pixels of a frame of moving picture data, to be transmitted over a CATV system are encoded by a known method, such as one of the Moving Picture Expert Group (MPEG) methods. Once the image data is encoded using an MPEG scheme or the like, this encoded data stream is used to modulate a carrier frequency for a channel in accordance with a known digital modulation scheme, such as QAM. The encoded data stream is used to modulate the amplitude of the carrier frequency to incorporate one of a predetermined number of pulses on the carrier wave. In one commonly used digital modulation scheme, there are 64 possible pulses that may be imposed onto the carrier wave. Each of these pulses may be perceived as corresponding to a point on a graphical representation. In a QAM-64 scheme, the graphical representation is depicted in FIG. 2. As shown in FIG. 2, the 64 points of the representation are centered about zero. The horizontal and vertical axes of the graph represent the orthogonal components of a modulation signal represented by a point. Thus, each signal may be described as a (x,y) point or as a phasor having a magnitude and angle. The graphical representation shown in FIG. 2 is known as a signal constellation, or constellation pattern, for a QAM signal, which in FIG. 2 is a QAM-64 signal. Signal distortions caused by a transmitter, propagation medium, or the demodulation components of a receiver may shift, attenuate, or amplify a modulation signal so it does not exactly correspond to one of the discrete points on a signal constellation for a modulation scheme. Maintenance or repair of a network 10 is an effort to locate the source of deteriorating performance within network 10 before it disrupts service in the network.

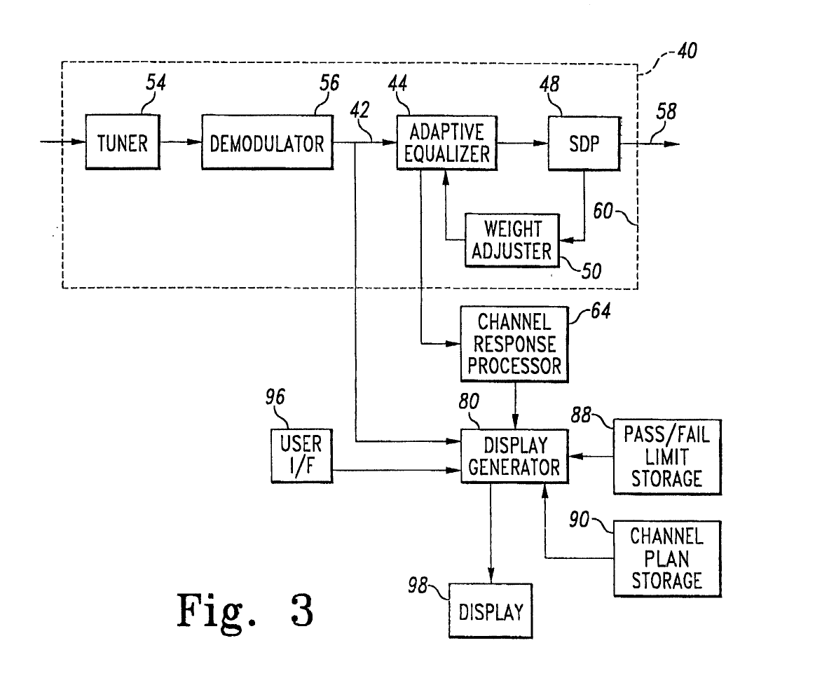

FIG. 3 is a block diagram of an exemplary system that may be coupled to the network of FIG. 1 to implement the phase analysis method of the present invention. The system includes a receiver 40 and a channel response processor 64. In the example discussed herein, receiver 40 includes an adaptive equalizer 44, a symbol decision processor 48, and a weight adjuster 50. The reader should appreciate that receiver 40 may suitably include other elements not related to the present invention.

The components of receiver 40 operate on an information signal recovered by demodulating the modulated carrier wave for a select channel. To this end, receiver 40 will preferably include, or be connected to, a tuner 54 and a demodulator 56. The tuner 54, which includes frequency conversion equipment and is well known in the art, tunes to a particular channel or frequency band that is being measured. Demodulator 56 then obtains the information signal 42, which is distorted or corrupted by the transmission equipment. Suitable digital demodulation equipment is well known.

Demodulated information signal 42 is provided to adaptive equalizer 44 and the output of the adaptive equalizer 44 is provided to symbol decision processor (SDP) 48. The transfer function of adaptive equalizer 44 compensates for the distortion of the demodulated information signal that was caused by the transfer function of the propagation medium and any network components that have operated on the signal after modulation of the carrier frequency at head end 12. To this end, the tap coefficients of adaptive equalizer 44 are adapted to compensate for the distortion in information signal 42 that demodulator 56 provides to adaptive equalizer 44. The response of adaptive equalizer 44 is adjusted by weight adjuster 50 in response to an error signal 60 generated by SDP 48.

To generate error signal 60, SDP 48 receives a signal pulse from adaptive equalizer 44 and determines which point in a constellation map best correlates to the pulse. Thus, SDP 48 determines what the pulse would have been if the signal had been transmitted and delivered to SDP 48 without any distortion. The difference between the point identified by the actual signal and the point determined to be the correct point by SDP 48 defines the error signal. Typically, this error signal has a component along both axes and, accordingly, the coefficients of adaptive equalizer 44 are complex. SDP 48 provides error signal 60 to weight adjuster 50. Weight adjuster 50 uses error signal 60 to adjust the weights or coefficients of the transfer function implemented by adaptive equalizer 44 to minimize the error signal.

As discussed above, SDP 48 determines what each received pulse of the information signal would have been without distortion. From this determination, SDP 48 generates a reconstructed information signal 58. Reconstructed information signal 58 is ideally the same as the information signal that was used to modulate the carrier frequency of the channel at head end 12. Ideally, error signal 60 generated by SDP 48 constitutes the difference between the output of adaptive equalizer 44 and reconstructed information signal 58. Reconstructed information signal 58 may be further be used to obtain the information signal content, if necessary for another function of receiver 40 that is outside the scope of the present invention.

In the process of minimizing the distortion in information signal 42, weight adjuster 50 adjusts the values of the tap coefficients in adaptive equalizer 44 so the output of adaptive equalizer 44 converges to the ideal demodulated information signal. As a consequence, the transfer function of adaptive equalizer 44 represents the inverse of the transfer function of the channel and network components that delivered the signal to adaptive equalizer 44.

The coefficients of the transfer function of adaptive equalizer 44 may be used by the channel response processor (CRP) 64 to generate the frequency response of the channel and the network components that delivered demodulated information signal 42 to adaptive equalizer 44. The frequency response may then be used to compute the phase angles of the frequency response as discussed below.

To implement the present invention, the receiver and CRP 64 of FIG. 3 may be coupled to a display generator 80, a pass/fail limit storage 88, a channel plan storage 90, a user interface 96, and a display 98 as shown in the figure. Display generator 80 may display the phase angle, group delay, and magnitude response data that may be compiled by CRP 64 along with the appropriate pass/fail limits retrieved from limit storage 88. The limits stored in storage 88 may be default limits or they may be limits defined by a user through user interface 96. The coefficients of adaptive equalizer 44 may be viewed on display 98 along with a distance from the receiver corresponding to each coefficient. CRP 64 may compute the distance corresponding to a coefficient by using the propagation constant of the communication medium over which a signal is being communicated and the time delay associated with each coefficient. The distance associated with each coefficient may be provided to display generator 80 and displayed with a value of each coefficient. The values of the coefficients are preferably expressed in decibels with respect to the magnitude of the center coefficient. Display generator 80 uses information signal 42 to display a constellation pattern for the demodulated signal in a known manner. In response to cursor position within the display and the activation of a zoom mode control through interface 96, display generator 80 provides various zoom levels and views of the constellation pattern.

CRP 64 may be a microprocessor or controller having memory and components for display output generated by CRP 64 to a user. For example, CRP 64 may be a Motorola 68331 with 1 MB of RAM. The processor is preferably coupled to an LCD or other display so a user may view the data generated by CRP 64. The microprocessor or controller may be coupled to the ASIC that implements adaptive equalizer 44, such as a BCM3125 manufactured by Broadcom of Irvine, Calif., by a serial/peripheral interface (SPI) so the coefficients of adaptive equalizer 44 may be supplied to CRP 64. Display 98 may be any well-known display device such as a CRT, LCD, or other computer display. Pass/fail limit storage 88 and channel plan storage 90 may be implemented as data structures within the memory of CRP 64 or they may be separate data storage units maintained in other memory. Adaptive equalizer 44 is often integrally formed with the demodulator 56 in many commercial devices, including the one described above.

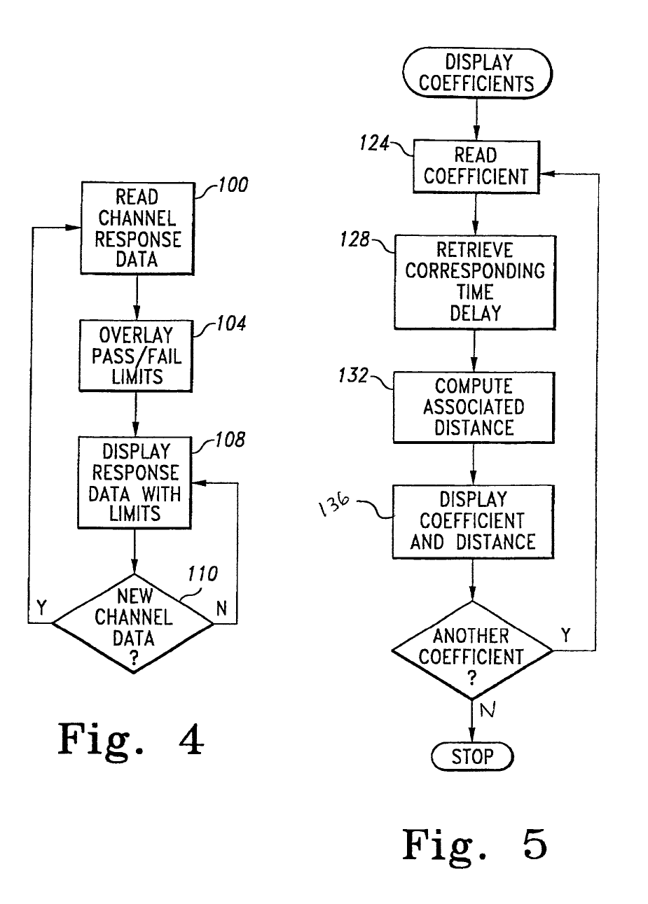

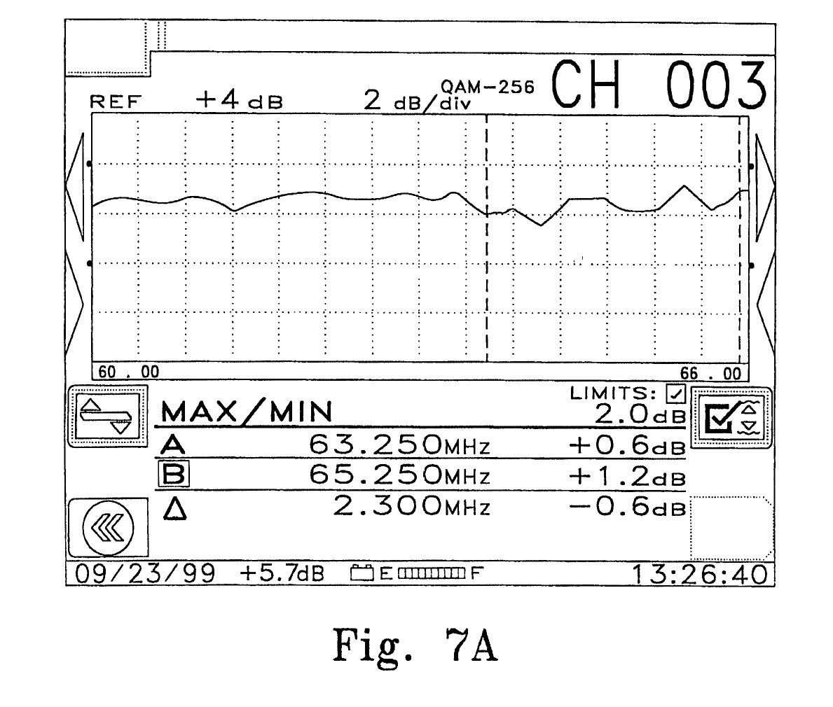

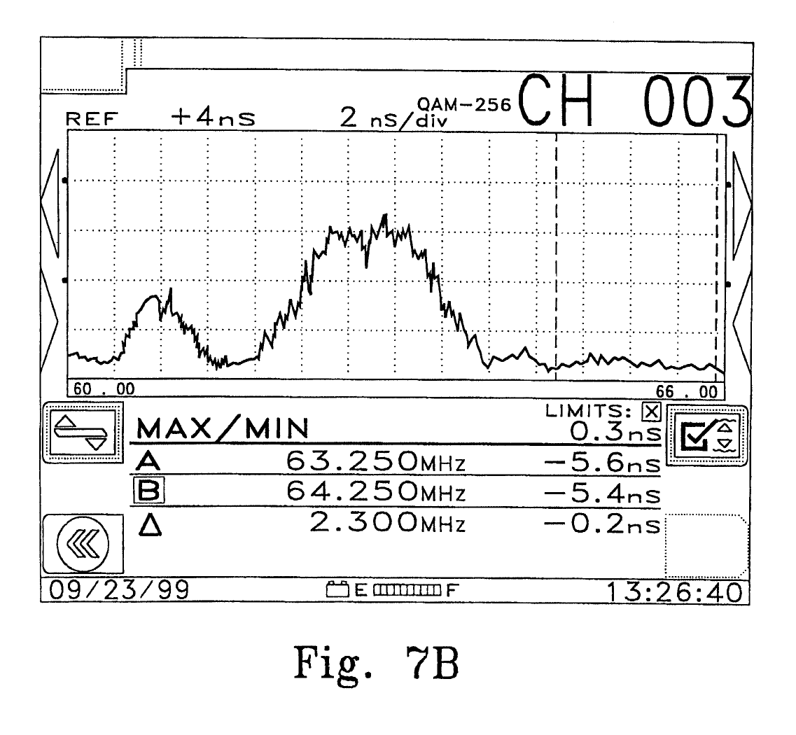

A flowchart of an exemplary process for displaying a response of the channel with a corresponding pass/fail limit is shown in FIG. 4. The process, which may be implemented in software executed by a processor of display generator 80, reads channel response data from CRP 64 (block 100). The channel response may be a magnitude response, a phase angle response, or a group delay plot as computed by CRP 64. CRP 64 may compute a phase angle and group delay response as disclosed in the cross-referenced application. The magnitude response may be computed as disclosed in Kletsky et al. or other known method. Display generator 80 then modifies its display memory with data points for the corresponding pass/fail limit retrieved from pass/fail limits storage 88 (block 104). For the magnitude plot, the pass/fail limits typically include a maximum and a minimum gain factor. Display generator 80 then drives display 98 using the modified data in its display buffer (block 108). Preferably, these limits are displayed as two horizontal lines and provided in a distinctive color to readily distinguish them from the magnitude data. Display 98 is then updated as the channel data change (block 110). For phase angle response data, the limits are a maximum and minimum phase angle while the limits are a maximum and minimum delay for group delay. Exemplary displays of a magnitude response with limits and group delay with limits are shown, respectively, in FIGS. 7A and 7B.

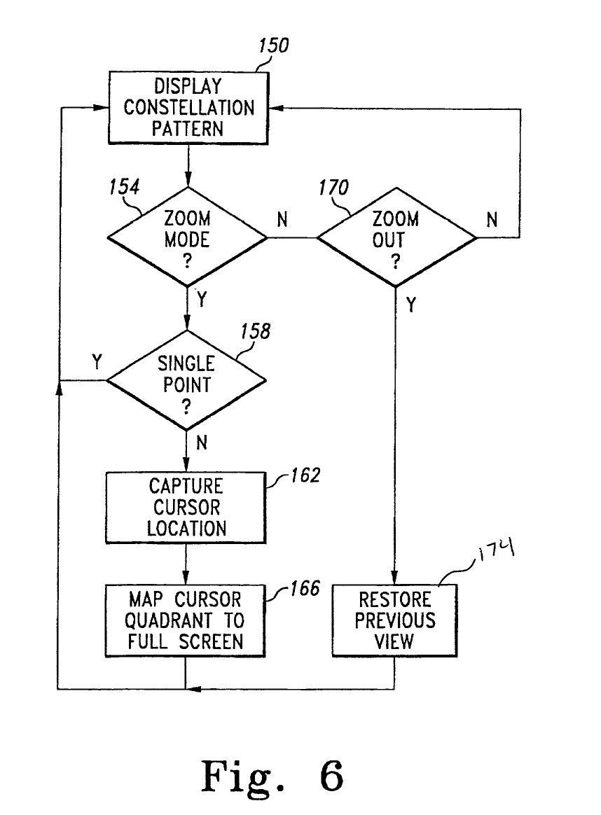

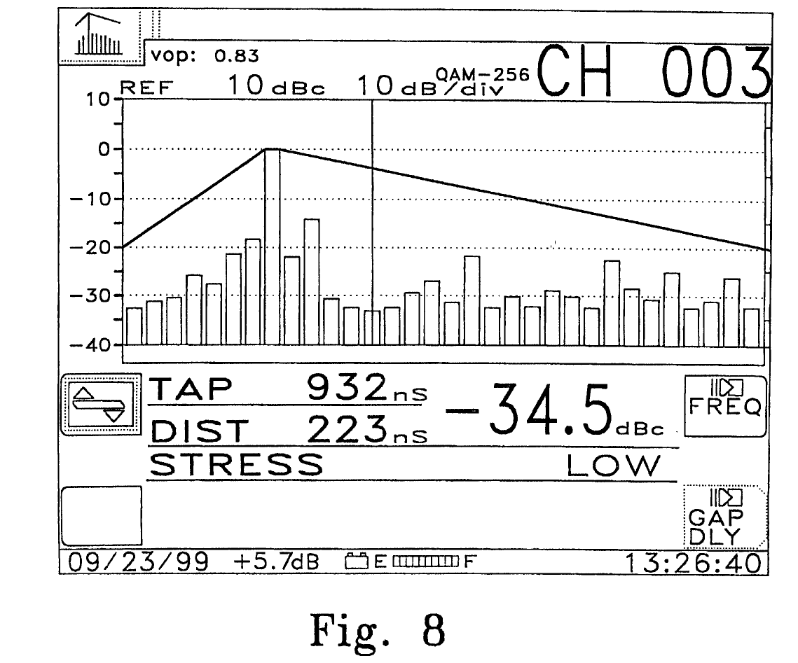

An exemplary method for displaying tap coefficients with distance data is shown in FIG. 6. An adaptive equalizer coefficient is read from adaptive equalizer 44 (block 124). For each coefficient, a corresponding time delay is retrieved (block 128). The time delay is a function of the equalizer design and is provided by its manufacturer. The time delay is multiplied by the velocity of propagation constant of the communication medium coupled to receiver 40 to determine a distance from the receiver corresponding to the tap coefficient (block 132). The distance and coefficient value are then provided to display generator 80 for modification of the display buffer (block 136). The resulting display permits a user to identify coefficients that have values indicating distortion in the channel and the corresponding distance gives an approximate location of the distortion production. Preferably, the coefficients are depicted as vertical bars indicating their magnitude in decibels with respect to the magnitude of the center tap. The process continues for the remaining coefficients (block 138). An exemplary display of a coefficient with its corresponding distance computation is shown in FIG. 8.

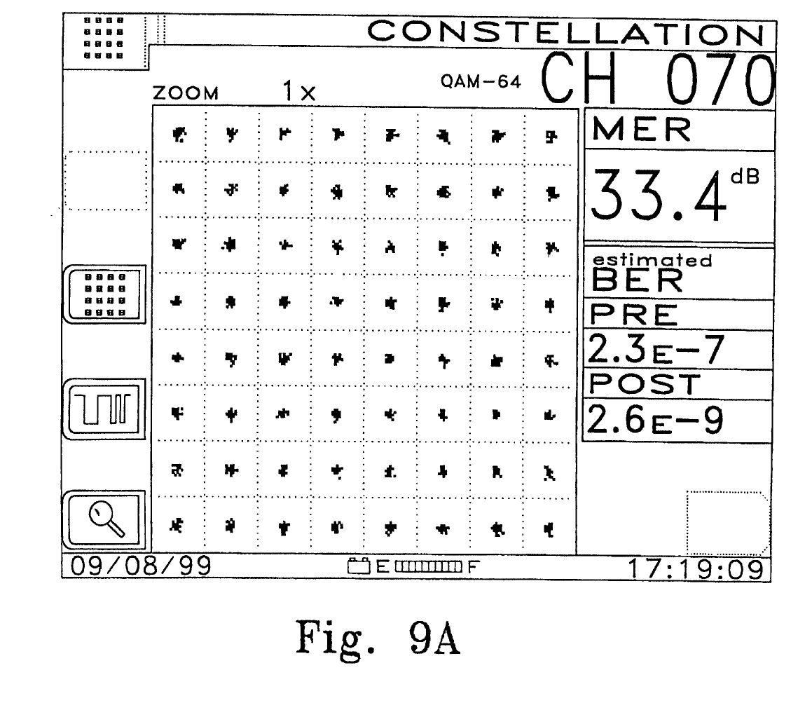

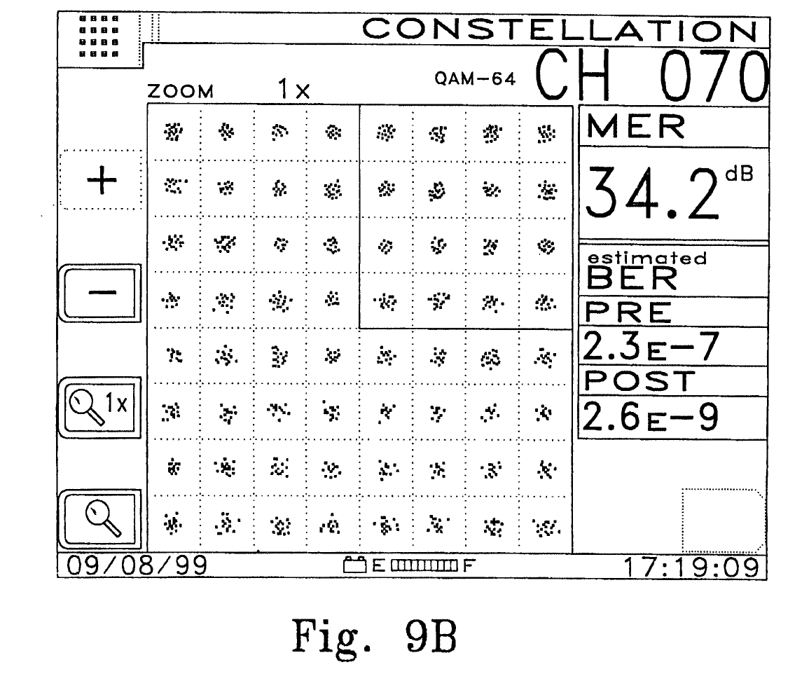

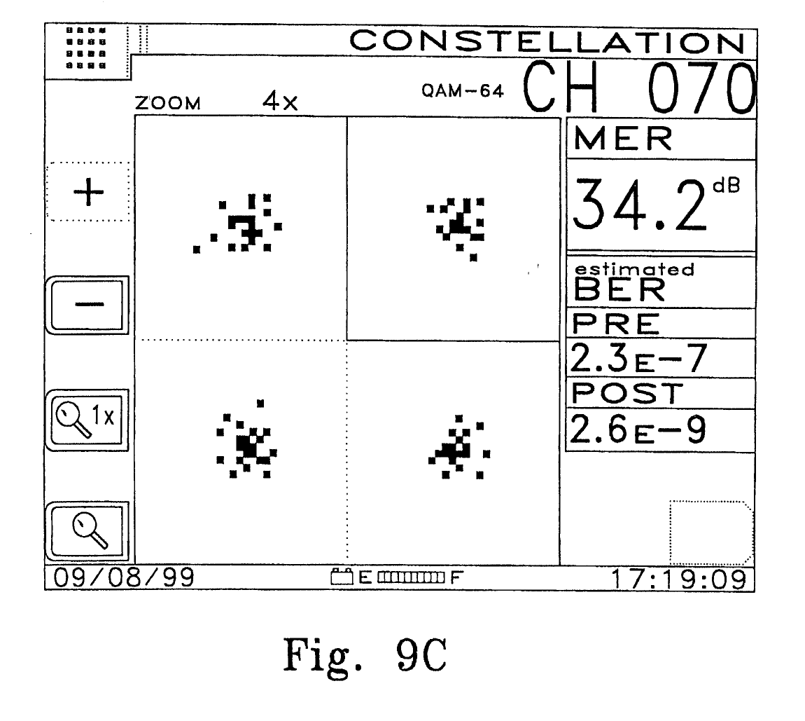

An exemplary zoom method is shown in FIG. 7. The method begins with the generation and display of a typical constellation pattern from the signal provided to adaptive equalizer 44 (block 150). Upon detection of zoom mode activation (block 154), the process determines whether a single constellation point is being displayed (block 158). If it is, the display is not changed (block 150). Otherwise, the location of the cursor is identified (block 162), and the signal data for the quadrant where the cursor is located is mapped to the full screen (block 166). The new screen data is displayed (block 150) until the another zoom activation occurs (block 154). The display is then updated to show the selected data at the full screen scale unless the display is comprised of a single constellation point (blocks 158-166). If the signal data associated with a single constellation point is being displayed, then the activation of the zoom mode does not alter the display (block 150). Detection of zoom out mode activation (block 170), causes the display to change to the four quadrant view of the previous level (block 174). Preferably, a zoom exit switch is provided at user interface 96 so activation of the switch allows the user to exit zoom mode. An exemplary display of a QAM-64 constellation pattern is shown in FIG. 9A and two successive zoom levels are shown in FIGS. 9B and 9C, respectively.

In implementing the present invention, CRP 64 and software for the phase angle response computations may be part of a network analyzer. Typically, network analyzers are computer systems with a display that are housed within a unit capable of transportation to various sites. A technician or other operator may take a network analyzer implementing the present invention to a distribution site 16 or subscriber site 22 and couple the analyzer to a receiver 40 at the site through an SPI. CRP 64 then obtains coefficients from adaptive equalizer 44 while it is operating without disrupting service to any sites downstream. Operating on these coefficients as described above, the phase angle and/or magnitude response may be determined and displayed to an operator for diagnostic purposes. The response data at a site may then be stored in the memory of the analyzer. An operator may then de-couple the analyzer from the site and take it to another distribution site 16 or subscriber site 22 for coupling to the network. At the second site, the response of the same channel analyzed at the first site may be obtained. The responses of the channel at the two sites may then be compared to determine the response of the network medium and components between the two sites. Alternatively, two different analyzers implementing the present invention may be used at each site. The response determined at a site may then be transmitted via a telemetry channel to head end 12 for comparison or to an analyzer at another site provided the network analyzers are provided with a transmitter/receiver for upconverting/downconverting data to be transmitted on a telemetry channel. In another implementation of the present invention, a receiver may implement the functionality of CRP 64 to perform self-diagnosis or for transmission of response data to head end 12. In any of these implementations or their equivalents, a response of a channel may be obtained to provide information about a network. In particular, the group delay of a channel may be determined. A network analyzer incorporating the components for displaying pass/fail limits, constellation patterns and tap coefficients may include the novel displays disclosed above. These displays enhance the value of the analyzer to a technician.

While the present invention has been illustrated by the description of exemplary processes, and while the various processes have been described in considerable detail, it is not the intention of the applicant to restrict or in any limit the scope of the appended claims to such detail. Additional advantages and modifications will also readily appear to those skilled in the art. The invention in its broadest aspects is therefore not limited to the specific details, implementations, or illustrative examples shown and described. Accordingly, departures may be made from such details without departing from the spirit or scope of applicant's general inventive concept.

What is claimed is:

1. A channel response analyzer comprising:
a channel response generator for generating one of a magnitude and phase angle response from response data for a quadrature amplitude modulated (QAM) receiver;
a channel response pass/fail limit storage; and
a display generator for generating a display for generating a display of the generated channel response and a limit stored with the pass/fail limit storage.

2. The channel response analyzer of claim 1 wherein the display generator displays the pass/fail limit as horizontal segments in conjunction with the generated channel response.

3. The channel analyzer of claim 2 wherein the channel response generator generates a group delay from the phase angle response.

4. The channel analyzer of claim 2 wherein the display generator displays the pass/fail limit in a color different than the display of the generated channel response.

5. A channel analyzer comprising:
a channel response processor for computing a distance of a network fault from a receiver corresponding to a time delay associated with a tap coefficient for an equalizer; and
a display generator for displaying the computed distance with a value for the tap coefficient.

6. A method for displaying diagnostic information regarding a channel in a CATV system comprising:
receiving one of a magnitude and a phase angle response of a QAM receiver; and
displaying the computed response with a pass/fail limit.

7. The method of claim 6 further comprising:
computing a group delay from the phase angle response.

8. The method of claim 7 wherein the displaying further comprising:
displaying the pass/fail limits in a color different than the computed group delay.

10. A method of displaying diagnostic data for a CATV network comprising:
computing a distance measurement corresponding to the distance of network fault from a quadrature amplitude modulated (QAM) receiver; and
displaying the computed distance with a corresponding tap coefficient value.

11. A method of displaying diagnostic data for a CATV network comprising:
detecting activation of a zoom mode during display of a constellation pattern; and
expanding a quadrant of the constellation pattern being displayed to occupy a full display screen.

12. The method of claim 11 further comprising:
identifying the quadrant to occupy the full display screen by cursor location in the constellation pattern being displayed when the zoom mode activation is detected.

13. The method of claim 11 further comprising:
moving a cursor to a quadrant of a current view of the constellation pattern; and
activating the zoom mode to fill the display with the portion of the constellation pattern corresponding to the location of the cursor before activation of the zoom mode.

14. The method of claim 11 further comprising:
detecting activation of a zoom out mode to return to the previous zoom level for the display.
